(19) United States
(12) Patent Application Publication
(10) Pub. No.: US 2016/0025962 A1
(43) Pub. Date: Jan. 28, 2016

(54) DISPLAY DEVICE

(71) Applicant: PIXTRONIX, INC., San Diego, CA (US)

(72) Inventors: Takehide Kuranaga, Mobara City (JP); Toshihiko Itoga, Mobara City (JP); Jun Fujiyoshi, Mobara City (JP); Masaya Adachi, Mobara City (JP)

(21) Appl. No.: 14/774,024

(22) PCT Filed: Mar. 14, 2014
(86) PCT No.: PCT/US2014/027065

§ 371 Date: Sep. 9, 2015

(30) Foreign Application Priority Data
Mar. 15, 2013 (JP) 2013-053197

(51) Int. Cl. G02B 26/02

(52) U.S. Cl. CPC G02B 26/02

(57) ABSTRACT

[PROBLEM] To provide a display device capable of improving the transmittance of light at an opening that passes light while maintaining high reflectivity in a reflective layer. [RESOLUTION MEANS] Use a metal film and an reflection increasing film to configure a reflective layer provided in an element substrate to effectively utilize light of a light source. Leave a silicon nitride film that is one portion of the reflection increasing film in the opening that passes the light of the light source while removing the metal film. At this time, the film thickness of the silicon nitride film in the reflection increasing film is ¼ the wavelength of incident light and, on the other hand, the film thickness of the silicon nitride film in the opening is ½ the wavelength of the incident light. The silicon nitride film that is one portion of the reflection increasing film and a passivation film provided in a top layer of an interlayer dielectric film are laminated in the opening to achieve this structure.

### RELATED APPLICATIONS

The present Application for Patent claims priority to Japanese Application No. 2013-053197, entitled “High Reflectance Aperture Layer With High Transmittance Aperture Opening,” filed Mar. 15, 2013, and assigned to the assignee hereof and hereby expressly incorporated by reference herein.

### TECHNICAL FIELD

An embodiment of the present invention relates to a technology for achieving effective use of light emitted from a light source.

### BACKGROUND TECHNOLOGY

A transmissive-type display device that includes a light source (backlight) on the back side of a display panel and displays an image by transmitting or blocking light emitted from a light source in each pixel is well-known. For example, in a liquid crystal display device, the amount of light transmitted from the light source (backlight) is controlled by an electro-optical effect of a liquid crystal. Furthermore, a display device that provides a mechanical shutter (hereinafter referred to simply as a “shutter”) using Micro Electro Mechanical Systems (MEMS) technology for each pixel and controls the light and darkness of each pixel through the mechanical opening and closing operation of the shutter to display an image has been developed (refer to Patent Document 1).

The display device disclosed in Patent Document 1 has an element substrate that provides a shutter formed at each pixel and a pixel circuit for driving the shutter, a reflective plate that forms an opening aligned with the position of each pixel and a light source. The reflective plate has functionality as a reflective plate and is arranged between the element substrate and the light source. And, devices have been derived using a reflective surface of the reflective plate arranged between the light source and the element substrate that generate multiple reflections of the light of the light source for effective utilization of the light.

### DOCUMENTS OF THE RELATED ART

### Patent Documents

[Patent Document 1] Japanese Unexamined Patent Application Publication (Translation of PCT Application) No.: 2008-533510

### SUMMARY OF THE INVENTION

### Problem to be Solved by the Invention

FIG. 10 illustrates the cross-sectional structure of the outline of a pixel in an element substrate 10. The element substrate 10 provides a switching element 16 on a glass substrate 14. The switching element 16 is buried by an interlayer dielectric film 18. A light source 12 is provided on the side opposite the switching element 16 and sandwiches the glass substrate 14. For effective utilization of the light emitted from the light source 12, a reflective layer 20 is sometimes provided on the element substrate 10. In order to raise reflectivity even more, the reflective layer 20 effectively provides an reflection increasing film 24 that uses the interference of light in addition to a metal film 22 having high reflectivity.

The reflection increasing film 24 is configured by stacking a plurality of thin films with differing refractive indexes. For example, a structure can be applied that stacks a silicon oxide film 24a and a silicon nitride film 24b that have different refractive indexes in the wavelength band of visible light.

The switching element 16 is provided on the reflective layer 20. A transistor, more specifically, a thin film transistor can be applied as the switching element 16. The switching element 16 provided in each pixel is selected using a signal of a scanning signal line (gate signal line), a video signal is provided from a data signal line, and a plurality of the pixels is integrated to display an image.

When the video signal is provided, the switching element 16 either passes the light passing through an opening 26 provided in the element substrate 10 based on the signal or controls the operation of a display element having a blocking shutter function. A liquid crystal element is well-known as a display element having a shutter function and controls the amount of transmitted light by an electro-optical effect. Furthermore, an object that passes or blocks light using mechanical movement like a MEMS shutter, as described in Patent Document 1, is well-known as a display element having other shutter functions.

Either way, when the reflective layer 20 is provided in the element substrate 10, light that is irradiated from the light source 12 that is irradiated to a region other than the opening 26 light (route (1) illustrated in FIG. 10) is reflected by the reflective layer 20 and recycled.

However, there is a problem with the structure illustrated in FIG. 10 in that the operating characteristics of the switching element 16 change due to light that is emitted from the light source 12 that is incident on the switching element 16 from the side surface of the opening 26 (route (3) illustrated in FIG. 10) thus reducing the contrast of a display panel. This type of defect is the same as when external light (route (4) illustrated in FIG. 10) is incident on the side surface of the opening 26.

On the other hand, the film thickness of the silicon nitride film 24a is optimized to improve reflectivity in the reflection increasing film 24. Accordingly, a problem occurs where transmittance decreases through the impact of the reflection of light incident in the opening 26 (route (2) illustrated in FIG. 10) by the silicon nitride film 24a.

In view of these types of problems, an object of an embodiment of the present invention is to provide a display device capable of improving the transmittance of light at the opening that passes light while maintaining high reflectivity in the reflective layer.

### Solution for the Problem

According to an embodiment of the present invention, a display device is provided, comprising: a light transmissive substrate, a metal film provided on the light transmissive substrate, a reflective layer having a reflection increasing film that laminates a first insulating film provided between the light transmissive substrate and the metal film and a second insulating film, a light source provided on the reflective layer side, an opening that passes through the second insulating film, the metal film and the insulating interlayer in a region that passes light emitted from the reflective layer side, a third insulating film provided in the bottom of the opening having a film thickness that is n/2 (n=an integer of 1 or more) of a wavelength of light irradiated from the light source, a switching element provided on the reflective layer, an insulating interlayer that buries the switching element, and a passivation film provided on the insulating interlayer.

According to this display device, reflection loss of the light from the light source in the opening can be reduced while light irradiated from the light source can be recycled by the reflective layer.

In another embodiment, there may be a planarizing insulating film between the insulating interlayer and the passivation film and the planarizing insulating film may cover the side wall of the opening.

In a display device having the opening that passes the light of the light source, stray light and external light from the light source can be prevented from being incident on the inside of the element substrate by providing a colored insulating film on the side wall of the opening.

In another embodiment, the third insulating film is configured by laminating the first insulating film and the passivation film. The first insulating film and the passivation film can be silicon nitride films and that the second insulating film be a silicon oxide film.

By extending the passivation film provided in the element substrate to the bottom of the opening while leaving the first insulating film that is a silicon nitride film in the bottom of the opening of the element substrate, a silicon nitride film having a different film thickness than the silicon nitride film in the reflection increasing film can be provided in the opening.

### Effect of the Invention

According to an embodiment of the present invention, transmittance is improved in an opening provided in an element substrate for passing light irradiated from a light source and thus effective utilization of the light can be achieved. Due to this, there is no need to increase the brightness of the light source more than necessary and thus power consumption can be reduced.

### BRIEF DESCRIPTION OF THE DRAWINGS

FIG. 1 is a cross-sectional view describing the configuration of a pixel region of an element substrate according to an embodiment of the present invention.

FIG. 2 is a cross-sectional view describing the configuration of a pixel region of an element substrate according to an embodiment of the present invention.

FIG. 3 is a cross-sectional view describing the configuration of a pixel region of an element substrate according to an embodiment of the present invention.

FIG. 4 is a cross-sectional view describing the configuration of a pixel region of an element substrate according to an embodiment of the present invention.

FIG. 5 is a cross-sectional view describing the configuration of a pixel region of a display device according to an embodiment of the present invention.

FIG. 6 is a plan view and a cross-sectional view describing the configuration of a pixel region of a display device according to an embodiment of the present invention.

FIG. 7 is a block diagram describing the configuration of a pixel region of a display device according to an embodiment of the present invention.

FIG. 8 is a perspective view describing the configuration of a shutter mechanism used in a display device according to an embodiment of the present invention.

FIG. 9 is a cross-sectional view describing the configuration of a pixel region of a display device according to an embodiment of the present invention.

FIG. 10 is a cross-sectional view describing the configuration of a pixel region of the display device.

### MODE FOR CARRYING OUT THE INVENTION

Embodiments of the present invention will be described hereinafter with reference to the drawings and the like. However, the present invention can be implemented in many different embodiments and should not be interpreted as being limited to the descriptions of the embodiments exemplified hereinafter.

### First Embodiment

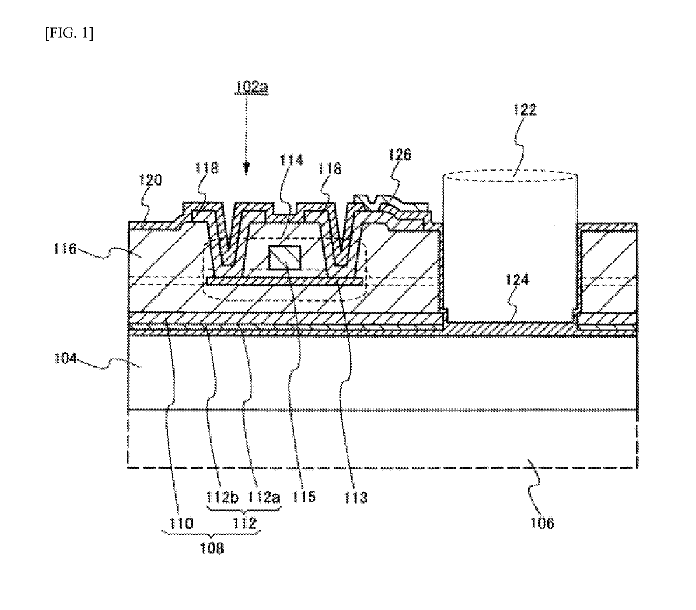

FIG. 1 illustrates a cross-sectional view of an element substrate 102a in a display device according to an embodiment of the present invention. FIG. 1 illustrates a cross-sectional view of one embodiment of a pixel in the display device according to the present embodiment. A glass substrate, for example, is used in the element substrate 102a as a light transmissive substrate 104. A reflective layer 108 is provided in the light transmissive substrate 104.

The reflective layer 108 includes a metal film 110 having high reflectivity and a reflection increasing film 112. The metal film 110 is formed of a metal film having high reflectivity such as aluminum, silver and the like. The reflection increasing film 112 is configured by a laminated body of a first insulating film 112a having a high refractive index and a second insulating film 112b having a low refractive index. For example, a silicon nitride film with a refractive index between 1.85 and 1.95 in the wavelength band of visible light can be used as the first insulating film 112a and a silicon oxide film with a refractive index between 1.45 and 1.48 in the same wavelength can be used as the second insulating film 112b. In some implementations, the optical film thicknesses of the first insulating film 112a and the second insulating film 112b in the reflection increasing film 112 can be of thicknesses that increase the light reflected by the interfaces of each layer and are, for example, ¼ the thickness of the wavelength of the incident light.

By laminating a dielectric film with a high refractive index alternately with a dielectric film with a low refractive index at a thickness like that describe above, reflective wave-fronts from the layers increase additively thus enabling an increase in reflectivity. For example, the reflectivity of a single metal film of aluminum and the like used as the metal film 110 is less than 90%, but reflectivity of 90% or more can be achieved by combining an reflection increasing film 112 like that described above.

The element substrate 102a provides a switching element 114 on the reflective layer 108. A transistor is one example of the switching element 114. The transistor is configured by including a semiconductor layer 113 and a lower gate electrode 115 that is insulated from the semiconductor layer 113. Being provided so as to be stacked with the reflective layer 108 arranges the switching element 114 so that light of a light source 106 is not directly irradiated. When the light of the light source 106 is incident on the semiconductor layer 113, an optical carrier is generated by a photoelectric effect because the operating characteristics of the transistor are changed.

The switching element 114 is buried by an insulating interlayer 116. The insulating interlayer 116 may be configured by including a first insulating layer located in the lower layer side of the semiconductor layer 113, a gate insulating layer and a second insulating layer provided in the upper layer side of the gate electrode. The switching element 114 is provided at a distance from the reflective layer 108 by the insulating interlayer 116 and thus the two are electrically isolated.

A contact hole is formed in and source and drain electrodes 118 that make contact with the semiconductor layer 113 are provided in the insulating interlayer 116. Furthermore, a passivation film 120 is provided on the source and drain electrodes 118 so as to coat the insulating interlayer 116.

In this type of element substrate 102a, an opening 122 is provided that penetrates the insulating interlayer 116, the metal film 110 and the second insulating film 112b of the reflection increasing film 112 in a position that passes the light of the light source 106. The first insulating film 112a in the reflection increasing film 112 is provided so as to extend into in the bottom of the opening 122 (surface side of the light transmissive substrate 104). When the configuration of the reflection increasing film 112, that is, the configuration of a dielectric multilayer film made from the first insulating film 112a and second insulating film 112b exists, reflectivity increases and thus at least the second insulating film 112b located in the upper layer in the region can be removed when the opening 122 is formed.

In order to ensure that alkali metals such as sodium and the like included in the glass substrate used as the light transmissive substrate 104 do not diffuse and contaminate the element substrate 102a, the silicon nitride film used as the first insulating film 112a can be left also in the region where the opening 122 is formed. However, when the silicon nitride film with film thickness adjusted in order to raise reflectivity is located in the opening 122, the amount of light transmitted from the light source 106 will decrease.

So, a third insulating layer 124 that has a different film thickness than the silicon nitride film used as the first insulating film 112a of the reflection increasing film 112 is provided in the bottom of the opening 122 and thus transmittance of the light is prevented from decreasing in this region. The third insulating film 124 is made thicker than the first insulating film 112a and can be formed with a film thickness that is n/2 (n=an integer of 1 or more) of the wavelength of incident light or more. Specifically, when the film thickness of the silicon nitride film used as the first insulating film 112a in the reflection increasing film 112 is between 40 nm and 60 nm, the film thickness of the third insulating film 124 in the opening 122 can be between 120 nm and 160 nm.

The third insulating film 124 may be stacked on the first insulating film 112a, may deposit a homogeneous insulating film and be of a thickness like that described above. The third insulating film 124 may be of a predetermined film thickness by forming a silicon nitride film as the passivation film 120 after forming the opening 122 that penetrates the insulating interlayer 116, the metal film 110 and the second insulating film 112b of the reflection increasing film 112. If the silicon nitride film is formed as the passivation film 120 using a plasma CVD method, the silicon nitride film can be deposited on the bottom and also the side wall of the opening 122 at a predetermined thickness without regard to the upper surface of the insulating interlayer 116. In this case, the deposited silicon nitride film can serve the function of the passivation film in the upper surface of the insulating interlayer 116 and the side wall of the opening 122 and perform the function of an optical distance adjusting film for reducing reflectivity in the bottom of the opening 122.

When the first insulating film 112a and the passivation film 120 are laminated so as to form a low reflecting film, the third insulating film 124 has the advantage that steps in the production process are also simplified. If the first insulating film 112a is a silicon nitride film, the passivation film 120 may also be formed of a silicon nitride film. However, in order to efficiently produce the light emitted from the light source 106 in the opening 122, the third insulating film 124 may be formed separately at a film thickness such that a low-reflection condition is produced on the surface of the light transmissive substrate 104 in the bottom of the opening 122. In this case, the third insulating film 124 is not limited to the silicon nitride film and thus other optically transparent insulating films such as a silicon oxide film and the like can be applied. Furthermore, even in a structure where the passivation film 120 is laminated on the first insulating film 112a of the reflection increasing film 112, as long as an optical film thickness that does not decrease transmittance in the region forming the third insulating film 124 can be achieved, the silicon nitride film can be replaced with another insulating film of aluminum oxide and the like that has optical transparency and has a passivation effect.

The opening 122 can be formed by continuously etching the insulating interlayer 116, the metal film 110 and the second insulating film 112b of the reflection increasing film 112 from the top layer to the bottom layer. In some implementations, the opening 122 can be formed by forming an opening in the reflective layer 108, burying the opening with the insulating interlayer 116 and then etching the insulating interlayer 116 so that an underlying surface (the first insulating film 112a) is exposed once more. According to such a 2-step process, the second insulating film 112b of the bottom layer can be etched with the metal film 110 of the top layer as a mask when etching is performed to form the opening in the reflective layer 108. Through this process, an opening end part in the reflective layer 108 can be aligned precisely and thus light scattering by this end part (edge part) can be reduced.

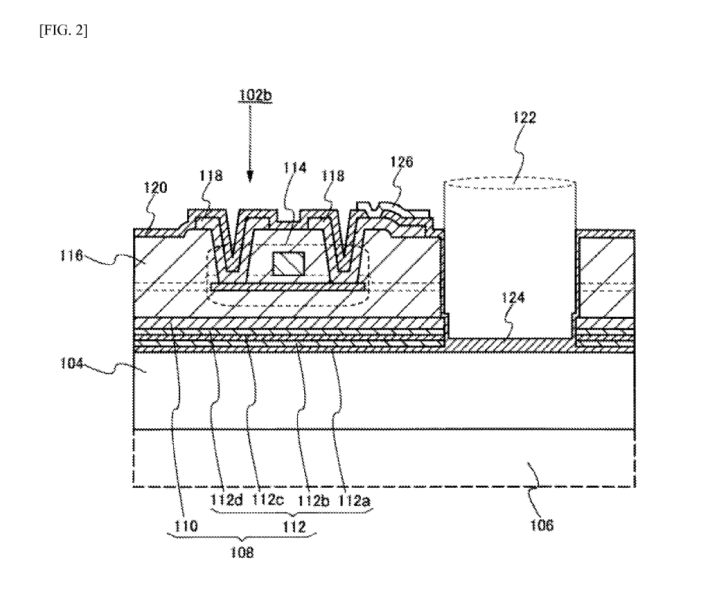

FIG. 2 illustrates the configuration of an element substrate 102b with additional layers forming the reflection increasing film 112 of the reflective layer 108 in the configuration of the element substrate 102a illustrated in FIG. 1. The reflection increasing film 112 is configured from a laminated body of a dielectric layer having a high refractive index and a dielectric layer having a low refractive index but even higher reflectivity can be achieved by further multi-layering this laminated structure to generate multiple reflections. FIG. 2 illustrates a configuration that laminates the first insulating film 112a, the second insulating film 112b, a fourth insulating film 112c and a fifth insulating film 112d sequentially as the reflection increasing film 112. Herein, the first insulating film 112a and the fourth insulating film 112c are homogeneous films and are, for example, silicon nitride films. Furthermore, the second insulating film 112b and the fifth insulating film 112d are silicon oxide films. Note that this laminated structure of a dielectric layer having a high refractive index and a dielectric layer having a low refractive index can be of any number of laminated layers so long as reflectivity improves.

On the other hand, the film thickness of the third insulating film 124 in the opening 122 is thicker than the film thickness of the first insulating film 112a in the reflection increasing film 112. That is, film thickness is n/2 (n=an integer of 1 or more) of the wavelength of incident light or more. The third insulating film 124 having this type of film thickness may be made so that the passivation film 120 is laminated to the first insulating film 112a.

Note that, except for the reflective layer 108, the configuration in FIG. 2 is that same as that in FIG. 1, the same effect as that in the first embodiment is achieved and thus a detailed description is omitted.

The present embodiment exemplifies a case where a silicon nitride film is used as the dielectric layer having a high refractive index and a silicon oxide film is used as the dielectric layer having a low refractive index but other dielectric material having optical transparency such as aluminum oxide having a refractive index of 1.63 or aluminum nitride having a refractive index of between 1.9 and 2.2 or the like may be combined.

As long as pixel electrodes 126 are provided on the passivation films 120, contact holes are formed in predetermined locations on the element substrates 102a and 102b and the source and drain electrodes are connected through the contact holes, the element substrate 102a illustrated in FIG. 1 and the kind of element substrate 102b illustrated in FIG. 2 can be used as backplanes for display devices.

As described above, according to the display device of the present embodiment, reflection loss of incident light in the opening that passes the light of the light source is reduced and thus effective utilization of the light can be achieved. Due to this, there is no need to increase the brightness of the light source more than necessary and thus power consumption of the display device can be reduced. Furthermore, by applying a configuration that uses the reflection increasing film in the reflective layer, reflectivity in the reflective layer and transmittance in the opening can both be improved. That is, the light intensity of the light emitted from the opening can be increased while the light emitted from the light source is recycled.

### Second Embodiment

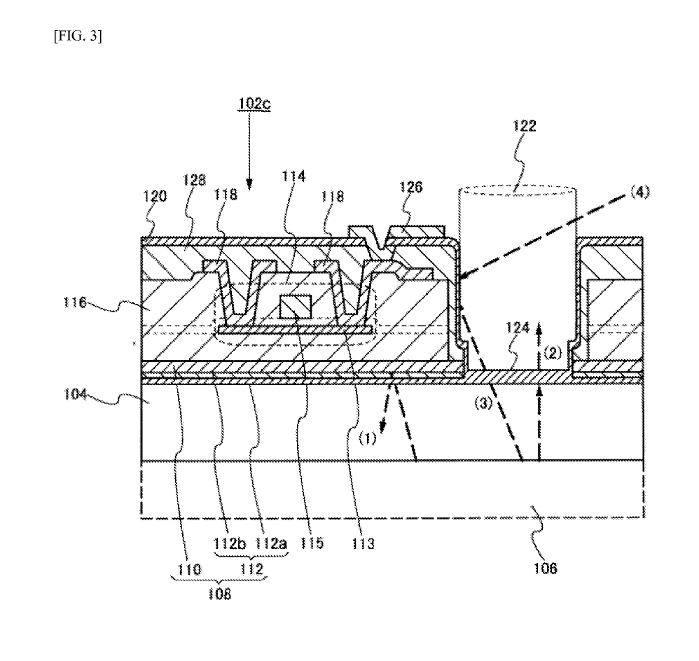

FIG. 3 illustrates an example of an element substrate 102c that additionally provides a planarizing insulating film 128 on the insulating interlayer 116 in the element substrate 102a described in reference to FIG. 1. Note that compositional elements in FIG. 3 that are the same as those in FIG. 1 are illustrated with the same reference numerals and that repetitive descriptions thereof are omitted.

In FIG. 3, the planarizing insulating film 128 provided on the insulating interlayer 116 is formed so as to cover the source and drain electrodes 118. In other words, the source and drain electrodes 118 are buried by the planarizing insulating film 118, the planarizing insulating film 118 buries unevenness occurring in the surface of the insulating interlayer 116 and thus the top layer surface thereof is flattened. The passivation film 120 is provided on the planarizing insulating film 128.

At this time, the planarizing insulating film 128 is removed from the opening 122 just as is the insulating interlayer 116, but is left on the side wall of the opening 122. After providing the opening 122 with the insulating interlayer 116, the metal film 110 and the second insulating film 112b removed, this type of structure can form the planarizing insulating film 128 over the whole surface by a coating method using an organic resin material and by selectively etching an organic resin layer left in the opening 122. As another method, the same structure can be formed by performing a development process so that an organic resin film formed on the bottom of the opening 122 is removed after the whole surface is coated with a photosensitive organic resin film.

By providing the planarizing insulating film 128 formed in this way using an organic resin material, it is also possible, for example, to form a relatively smooth curved surface in the top end part of the opening 122 and the coverage of unevenness by the passivation film 120 formed on the top layer of the planarizing insulating film 128 can be improved in such a case.

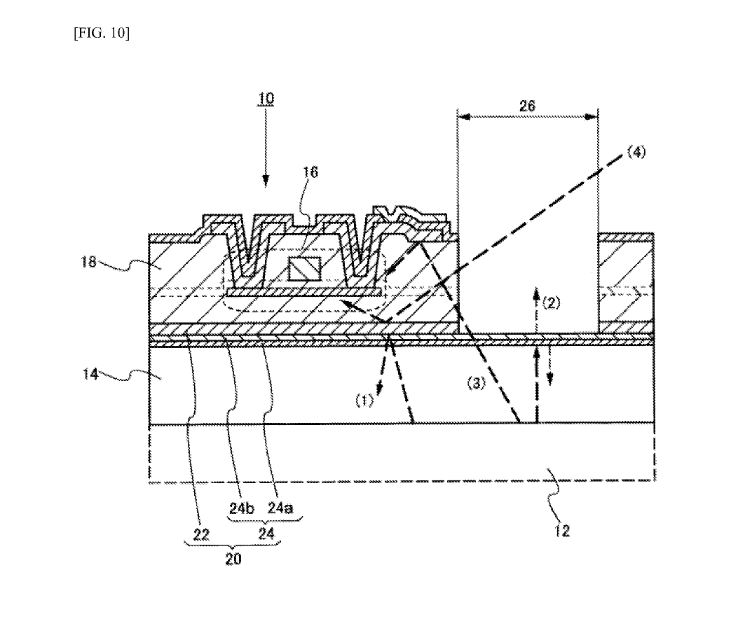

By coloring the planarizing insulating film 128 and covering the side wall portions of the opening 122, negative impacts exerted on the operation of the switching element 114 by scattering light from the light source 106 (route (3) in FIG. 3) and external light (route (4) in FIG. 3) incident from the side wall of the opening 122 can be prevented as described in FIG. 10. The planarizing insulating film 128 can be colored by including a specific crosslinking agent in a resist composition. Furthermore, coloring may be done by coating the element substrate 102c with a resist composition and carbonizing by baking at a relatively high temperature.

By providing the third insulating layer 124 that has a different film thickness than the first insulating film 112a of the reflection increasing film 112 in the bottom of the opening 122, the third insulating film 124 can prevent the transmittance of light from decreasing in this area (route (2) in FIG. 3). The third insulating film 124 is made thicker than the first insulating film 112a and can be formed with a film thickness that is n/2 (n=an integer of 1 or more) of the wavelength of incident light or more. Specifically, when the film thickness of the silicon nitride film used as the first insulating film 112a in the reflection increasing film 112 is between 40 nm and 60 nm, the film thickness of the third insulating film 124 in the opening 122 can be between 120 nm and 160 nm. For example, film thickening can be done by also forming the passivation film 120 formed of a silicon nitride film from the side wall to the bottom of the opening 120. In this case, the deposited silicon nitride film can serve the function of the passivation film in the upper surface of the insulating interlayer 116 and the side wall of the opening 122 and perform the function of an optical distance adjusting film for reducing reflectivity in the bottom of the opening 122.

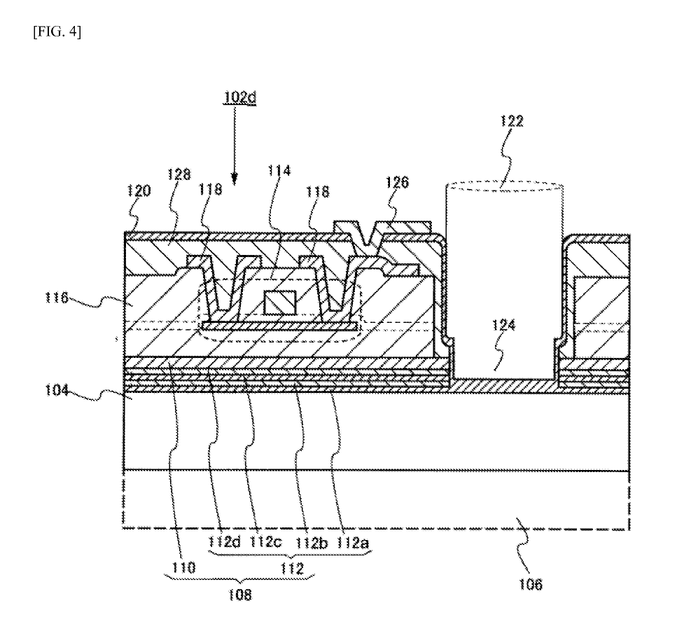

FIG. 4 illustrates the configuration of an element substrate 102d with additional layers forming the reflection increasing film 112 of the reflective layer 108 in the configuration of the element substrate 102c illustrated in FIG. 3. The reflection increasing film 112 is configured from a laminated body of a dielectric layer having a high refractive index and a dielectric layer having a low refractive index but even higher reflectivity can be achieved by further multi-layering this laminated structure to increase an impudent interference effect of the light. FIG. 4 illustrates a configuration that laminates the first insulating film 112a, the second insulating film 112b, a fourth insulating film 112c and a fifth insulating film 112d sequentially as the reflection increasing film 112. Herein, the first insulating film 112a and the fourth insulating film 112c are homogeneous films and are, for example, silicon nitride films. Furthermore, the second insulating film 112b and the fifth insulating film 112d are silicon oxide films. Note that this laminated structure of a dielectric layer having a high refractive index and a dielectric layer having a low refractive index can be of any number of laminated layers so long as reflectivity improves.

Note that, except for the reflective layer 108, the configuration in FIG. 4 is the same as that in FIG. 2, that the same effect is achieved and thus that a detailed description is omitted.

The present embodiment exemplifies a case where a silicon nitride film is used as the dielectric layer having a high refractive index and a silicon oxide film is used as the dielectric layer having a low refractive index but, just as in the first embodiment, other dielectric material having optical transparency such as aluminum oxide having a refractive index of 1.63 or aluminum nitride having a refractive index of between 1.9 and 2.2 or the like may be combined.

As long as a pixel electrode 126 is provided on the passivation films 120 and the source and drain electrodes are connected through the contact holes, the element substrate 102c illustrated in FIG. 3 and the kind of element substrate 102d illustrated in FIG. 4 can be used as backplanes for display devices. The pixel electrode 126 can be formed on top of the planarizing insulating film 128 at this time and thus an aperture ratio can be improved without receiving any impact from the unevenness of the underlying surface.

As described above, according to the display device of the present embodiment, reflection loss of incident light in the opening that passes the light of the light source is reduced and thus effective utilization of the light can be achieved. Due to this, there is no need to increase the brightness of the light source more than necessary and thus power consumption of the display device can be reduced. Furthermore, by applying a configuration that uses the reflection increasing film in the reflective layer, reflectivity in the reflective layer and transmittance in the opening can both be improved. That is, the light intensity of the light emitted from the opening can be increased while the light emitted from the light source is recycled.

Additionally, by providing the planarizing insulating film in the element substrate, coloring and then providing the planarizing insulating film also on the side wall of the opening, scattering light can be prevented from being incident on and exerting a negative impact on the operation of the switching element. Furthermore, display panel contrast can be improved.

### Third Embodiment

The present embodiment exemplifies one embodiment of a display device that provides a MEMS shutter mechanism as a display element using the element substrate 102a illustrated in the first embodiment.

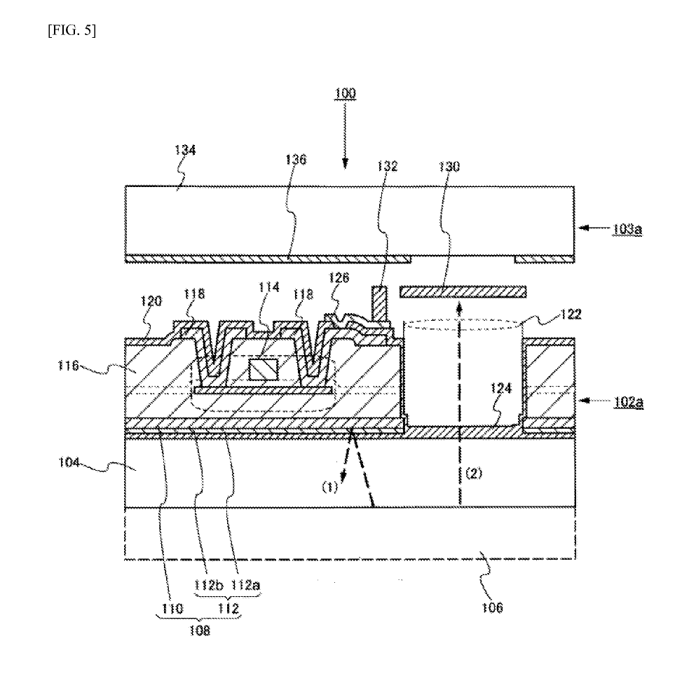

FIG. 5 illustrates a cross-sectional view of one embodiment of a pixel in the display device 100 that provides a MEMS shutter in the pixel. The element substrate 102a has the same configuration as that described with reference to FIG. 1 in the first embodiment and thus a detailed description is omitted. The pixel electrode 126 that is electrically connected with the switching element 114 is connected to a shutter driving part 132. The shutter driving part 132 controls a switching operation of a shutter 130 based on a control signal provided through the switching element 114. The shutter 130 is provided in a light path of the light (route (2) illustrated in FIG. 5) emitted from the light source 106. That is, the shutter 130 is provided so as to substantially overlap the opening 122 and the shutter 130 operates so as to be in a position that blocks emitted light of the light source 106 when “closed” and to be in a position that passes the light when “open” and is controlled by the shutter driving part 132.

Through a synergistic effect of the metal film 110 and the reflection increasing film 112, the reflective layer 108 effectively recycles the light emitted from the light source 106 and can thus strengthen the intensity of the light emitted toward the opening 122. Furthermore, the third insulating film 124 set at a low-reflection optical film thickness is provided in the opening 122 and thus suppresses reflection loss of the light incident toward the opening 122 side through the light transmissive substrate 104. Therefore, the light of the light source 106 can be utilized effectively and thus the power consumption of the display device 100 can be suppressed. Furthermore, if the reflection increasing film 112 is multilayered as in the element substrate 102b illustrated in FIG. 2 and as in the element substrate 102d illustrated in FIG. 4, utilization efficiency of the light of the light source can be raised even more.

Note that a counter substrate 103a is provided in the display device 100 so that the shutter mechanism is not exposed, as illustrated in FIG. 5. The counter substrate 103a includes a light shielding film 136 on an optically transparent glass substrate 134. The light shielding film 136 is provided to suppress glare as seen from the display surface and is provided with an opening in a position that is substantially the same as that of the opening 122 of the element substrate 102a.

FIG. 5 exemplifies a case using the element substrate 102a illustrated in FIG. 1 as described in the first embodiment but the element substrate 102c illustrated in FIG. 3 as described in the second embodiment may be used instead. By providing the colored planarizing insulating film 128, the element substrate 102c can omit the light shielding film 136 in the element substrate 103a. The colored planarizing insulating film 128 prevents the reflection of external light and prevents the incidence of stray light from external light or the light source 106 even in such a configuration and can thus prevent the deterioration of the switching element 114 characteristics and maintain high contrast in the display panel.

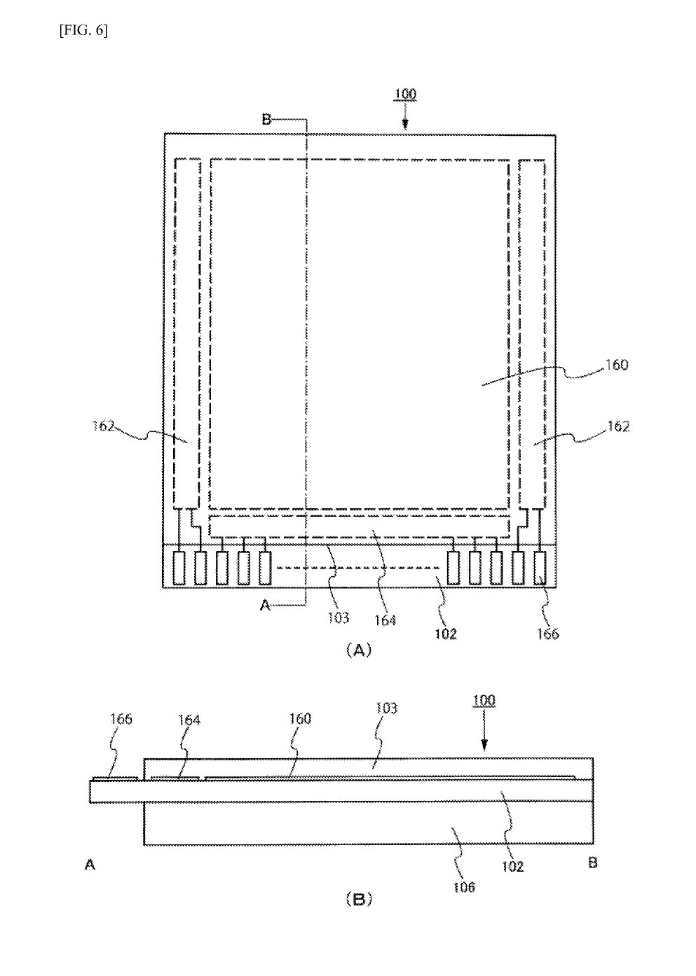

FIG. 6 (A) is a plan view illustrating the configuration of a display device using this type of shutter mechanism and FIG. 6 (B) is a cross-sectional view corresponding to plane-cutting line A-B. The display device 100 has an element substrate 102 that forms a pixel using a switching element and a shutter mechanism, and a counter substrate 103 provided facing the element substrate 102. The light source 106 is provided on the element substrate 102 side.

A display part 160 includes a plurality of pixels. A switching element and a shutter mechanism is provided in each of the pixels. Furthermore, a gate driver 162 that drives the display part 160, a data driver 164 and a terminal 166 that inputs a signal are provided as appropriate. Note that in the example illustrated in FIG. 6 the gate driver 162 is arranged so as to sandwich the display part 160 but is not limited to this.

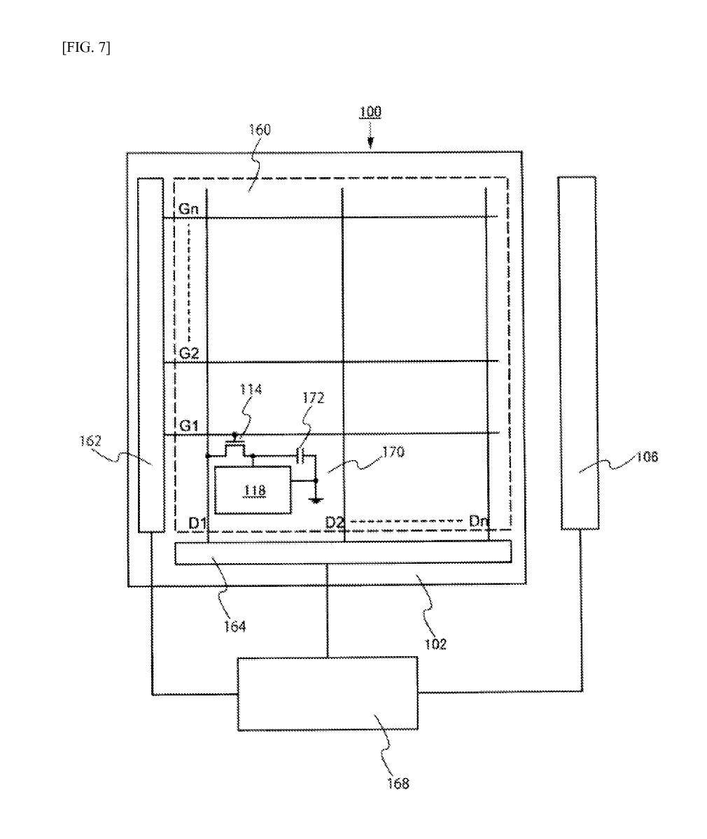

FIG. 7 is a circuit block diagram illustrating one example of the display device 100. In the display device 100, an image signal and a scanning signal are supplied to the data driver 164 and the gate driver 162 from a controller 168. Furthermore, in the display device 100, light is supplied from the light source 106 that is controlled by the controller 168.

The display part 160 provides a pixel 170 that includes a shutter mechanism 158 arranged in the form of a matrix, the switching element 114 and a capacitor 172. The data driver 164 supplies a data signal to the switching element 114 through a data line (D1, D2, . . . , Dm). The gate driver 162 supplies a gate signal to the switching element 114 through a gate line (G1, G2, . . . , Gm). The switching element 114 drives the shutter mechanism 158 based on the data signal supplied from the data line (D1, D2, . . . , Dm).

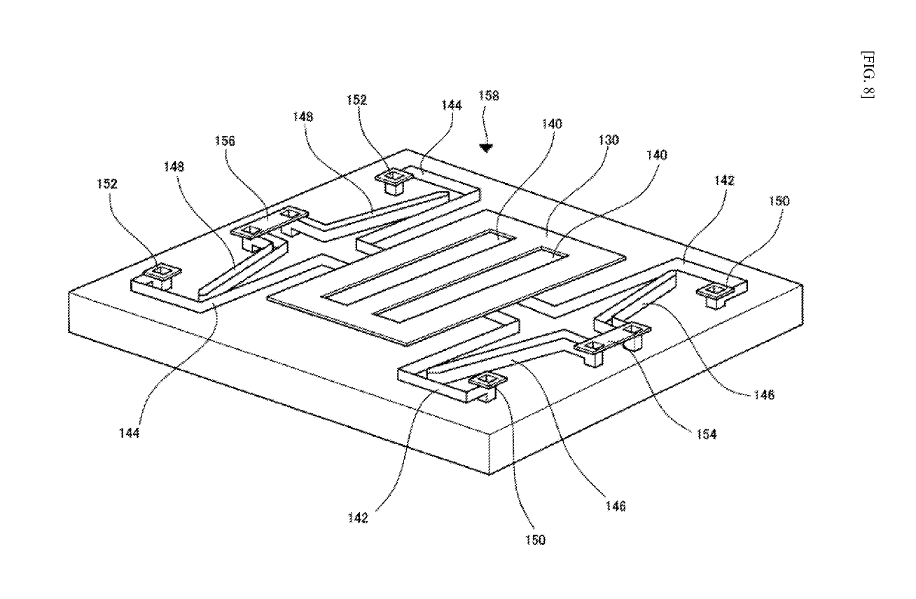

FIG. 8 illustrates the shutter mechanism 158 used in the display device 100. The shutter mechanism 158 has the shutter 130, first springs 142 and 144, second springs 146 and 148, first anchor parts 150 and 152, and second anchor parts 154 and 156. These are provided in a translucent element substrate 102 together with the switching element. The shutter 130 has a shutter opening 140 and thus the shutter 130 main body becomes a light-shielding part.

The shutter 130 is formed of a non-transparent member and when the shutter opening 140 thereof and an opening of a reflective plate provided in the element substrate 102 substantially overlap, the light of the light source passes through and when the shutter 130 portion substantially overlaps the opening, the light of the light source is blocked.

The shutter 130 is connected on one side to the first anchor 150 through the first spring 142. And, furthermore, is connected on the other side to the first anchor parts 152 through the first spring 144. The first anchor parts 150 and 152 function together with the first springs 142 and 144 to hold the shutter 130 in a state of suspension from the surface of the translucent element substrate 102.

The first anchor part 150 is electrically connected to the first spring 142. Therefore, when bias potential is supplied to the first anchor part 150 the first spring 142 reaches substantially the same potential. The relationship between the first anchor part 152 and the first spring 144 is the same. The second spring 146 is connected to the second anchor part 154. The second anchor part 154 functions to hold the second spring 146. The second anchor part 154 is electrically connected to the second spring 146. The second anchor 154 reaches ground potential and thus the second spring 146 also reaches ground potential. The relationship between the second anchor part 156 and the second spring 148 is the same.

When a specified bias potential is supplied to the first spring 142 and the second spring 146 reaches ground potential, the first spring 142 and the second spring 146 are electrostatically driven by the potential difference between the two and by moving so as to attract one another cause the shutter 130 to slide in one direction. Furthermore, when bias potential is supplied to the first spring 144 and ground potential is supplied the second spring 148, the first spring 144 and the second spring 148 are electrostatically driven by the potential difference between the first spring 144 and the second spring 148 and by moving so as to attract one another cause the shutter 130 to slide in an opposite direction.

Note that the shutter mechanism 158 illustrated in FIG. 8 is only one example of a shutter mechanism that can be used in the display device 100 and as long as a shutter can be driven by the switching element, any embodiment thereof can be used.

According to the display device of the present embodiment that uses the MEMS shutter mechanism, reflection loss of incident light in the opening that passes the light of the light source is reduced and thus effective utilization of the light can be achieved. Due to this, there is no need to increase the brightness of the light source more than necessary and thus power consumption of the display device can be reduced. Furthermore, by applying a configuration that uses the reflection increasing film in the reflective layer, reflectivity in the reflective layer and transmittance in the opening can both be improved. That is, the light intensity of the light emitted from the opening can be increased while the light emitted from the light source is recycled.

### Fourth Embodiment

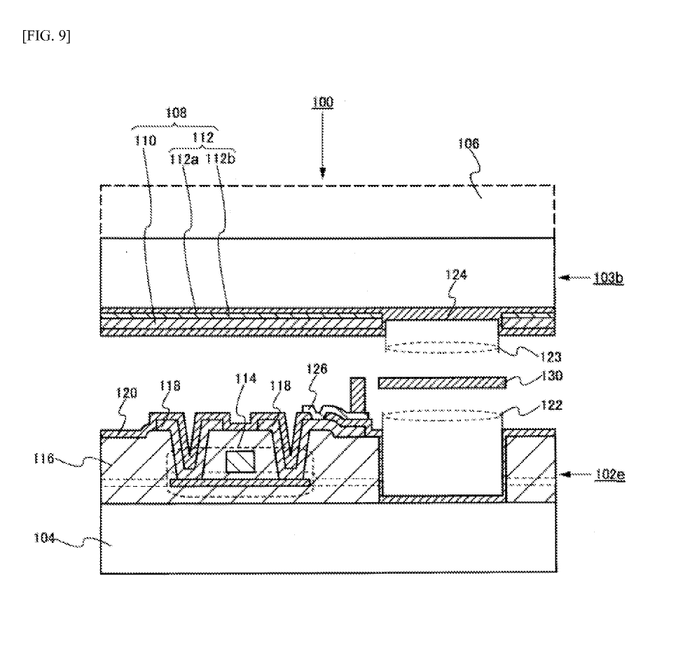

The present embodiment illustrates the display device 100 with the light source 106 on the side of a counter substrate 103b. The display device 100 illustrated in FIG. 9 exemplifies a configuration with the MEMS shutter mechanism in a pixel and provides an element substrate 102e and the counter substrate 103b.

The light source 106 is provided on the counter substrate 103b side and thus the reflective layer 108 is also provided in the counter substrate 103b. The reflective layer 108 is formed from the metal film 110 having high reflectivity and the reflection increasing film 112. Just as in the first embodiment, the reflection increasing film 112 is formed from a laminated body of a dielectric layer having a high refractive index and a dielectric layer having a low refractive index. For example, the reflection increasing film 112 is formed by laminating the first insulating film 112a and the second insulating film 112b.

The metal film 110 and the second insulating film 112b are removed from an opening 123 of the counter substrate 103b. Therefore, the first insulating film 112a with film thickness adjusted to raise reflectivity is left in the opening 123 and thus effective utilization of the light emitted from the light source 106 is not achieved. Therefore, an insulating film that is the same as the first insulating film 112a is formed on top of the metal film 110 and the third insulating film 124 that is a thick film is provided in the opening 123.

Providing the third insulating film 124 that has different film thickness than the first insulating film 112a of the reflection increasing film 112 in the opening 123 in this way, even when the reflective layer 108 is provided in the counter substrate 103b, makes it possible to prevent the transmittance of light in this region from decreasing. The third insulating film 124 is made thicker than the first insulating film 112a and can be formed with a film thickness that is n/2 (n=an integer of 1 or more) of the wavelength of incident light or more. Specifically, when the film thickness of the silicon nitride film used as the first insulating film 112a in the reflection increasing film 112 is between 40 nm and 60 nm, the film thickness of the third insulating film 124 in the opening 122 can be between 120 nm and 160 nm.

In FIG. 9, the element substrate 102e omits the reflective layer 108 from the element substrate 102a illustrated in FIG. 1, but otherwise has the same configuration and thus a detailed description is omitted.

By making the configuration of a reflective layer provided in a counter substrate the same as that illustrated in the first embodiment as in the present embodiment, light from a light source can be effectively utilized even in a display device that arranges the light source on the counter substrate side. Due to this, there is no need to increase the brightness of the light source more than necessary and thus power consumption of the display device can be reduced. Furthermore, by applying a configuration that uses the reflection increasing film in the reflective layer, reflectivity in the reflective layer and transmittance in the opening can both be improved.

### DESCRIPTION OF THE NUMERICAL REFERENCES

10 Element substrate

12 Light source

14 Glass substrate

16 Switching element

18 Interlayer dielectric film

20 Reflective layer

22 Metal film

24 Reflection increasing film

26 Opening

100 Display device

102 Element substrate

103 Counter substrate

104 Glass substrate

106 Light source

108 Reflective layer

110 Metal film

112 Reflection increasing film

113 Semiconductor layer

114 Switching element

115 Gate electrode

116 Insulating interlayer

118 Source and drain electrodes

120 Passivation film

122 Opening

123 Opening

124 Third insulating film

126 Pixel electrode

128 Planarizing insulating film

130 Shutter

132 Shutter driving part

134 Glass substrate

136 Light shielding film

140 Shutter opening

142 First spring

144 First spring

146 Second spring

148 Second spring

150 First anchor part

152 First anchor part

154 Second anchor part

156 Second anchor part

158 Shutter mechanism

160 Display part

162 Gate driver

164 Data driver

166 Input terminal

168 Controller

170 Pixel

172 Capacitor

What is claimed is:

1. A display device, comprising:
a light transmissive substrate,
a metal film provided on the light transmissive substrate,
a reflective layer having an reflection increasing film that laminates a first insulating film provided between the light transmissive substrate and the metal film and a second insulating film,
a light source provided on the reflective layer side,
an opening that passes through the second insulating film, the metal film and the insulating interlayer layer in a region that passes light emitted from the reflective layer side,
a third insulating film provided in the bottom of the opening having a film thickness that is n/2 (n=an integer of 1 or more) of a wavelength of light irradiated from the light source,
a switching element provided on the reflective layer,
an insulating interlayer that buries the switching element, and
a passivation film provided on the insulating interlayer.

2. The display device according to claim 1 further comprising a planarizing insulating film between the insulating interlayer and the passivation film wherein the planarizing insulating film covers a sidewall of the opening.

3. The display device according to claim 2 wherein the planarizing insulating film is colored.

4. The display device according to any one of claims 1 through 3 wherein the third insulating film is formed by laminating the first insulating film and the passivation film.

5. The display device according to any one of claims 1 through 4 wherein the first insulating film and the passivation film are silicon nitride films and the second insulating film is a silicon oxide film.
